(19) United States
(12) Patent Application Publication
(10) Pub. No.: US 2025/0371361 A1
(43) Pub. Date: Dec. 4, 2025

(54) AUTOMATED SELF-SUPERVISED MACHINE LEARNING SERVICES THROUGH UNIFIED MACHINE LEARNING ENABLERS

(71) Applicant: STRIPE, INC., South San Francisco, CA (US)

(72) Inventors: Ramy Shoker, Seattle, WA (US); Denis Pokataev, New York, NY (US); Eliot Abrams, New York, NY (US)

(21) Appl. No.: 18/732,251

(22) Filed: Jun. 3, 2024

(51) Int. Cl. G06N 3/09

(52) U.S. Cl. CPC G06N 3/09

(57) ABSTRACT

A method for generating a chain of machine learning models includes: receiving a data sample including one or more features and a target property; identifying, by a processor of a computer system, an unsupervised machine learning model trained to classify data samples based on the one or more features, independently of the target property, into a plurality of clusters; classifying the data sample based on the one or more features using the unsupervised machine learning model to compute a cluster; identifying, by the processor, a supervised machine learning model corresponding to the cluster; and computing a value for the target property by supplying the data sample to the supervised machine learning model.

### BACKGROUND

Supervised machine learning generally relates to training a statistical model to implement a function that maps from input independent variables to one or more output dependent variables. The training is performed based on training data, which includes data samples, each data sample including one or more input values (e.g., a vector of predictor variables) and a label representing a desired output value corresponding to those input values. The training process relates to computing parameters of the statistical model (e.g., weights and biases) to generate outputs that track the labels in the training data. For example, a model may be trained to estimate home prices based on training data with input variables including square footage, lot size, number of bedrooms, number of bathrooms, zip code, and the like and with labels corresponding to the actual sales prices of those homes. Training the model relates to updating the parameters to reduce or minimize the overall error or difference between the output of the model and the labels in the training data.

Self-supervised learning (SSL) is a paradigm in machine learning where a model is trained on a task using the data itself to generate supervisory signals, rather than relying on external labels provided by humans.

The above information disclosed in this Background section is only for enhancement of understanding of the present disclosure, and therefore it may contain information that does not form the prior art that is already known to a person of ordinary skill in the art.

### SUMMARY

The present disclosure is directed to automated self-supervised machine learning services, substantially as shown in and/or described in connection with at least one of the figures, as set forth more completely in the claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram illustrating a data-driven inference system according to one embodiment of the present disclosure.

FIG. 2 is a block diagram illustrating the composition, by an orchestrator of a data-driven inference system, of two machine learning models into a chain to compute an inference value according to one embodiment of the present disclosure.

FIG. 3 is a flowchart of a method 300 for generating a chain of one or more machine learning models according to one embodiment of the present disclosure.

FIG. 4 is a block diagram of a data-driven inference system in which an existing interface for interacting with an outlier detection machine learning model is modified to accept requests and to orchestrate chains of machine learning models according to one embodiment of the present disclosure.

FIG. 5 is a block diagram illustrating a high-level network architecture of a computing system environment for operating a processing system according to embodiments of the present disclosure.

FIG. 6 is a block diagram illustrating a representative software architecture, which may be used in conjunction with various hardware architectures as described herein.

FIG. 7 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Some aspects of embodiments of the present disclosure relate to a data-driven inference system that automatically computes labels for populations based on historical data and modularly connects multiple trained machine learning models and/or apply single trained machine learning models, in accordance with the type of computation supplied in an input request. While some aspects of embodiments of the present disclosure are describe herein in the context of providing pricing guidance such as the customized pricing of products as one example, embodiments of the present disclosure are not limited thereto and may be applied to automatically computing or estimating other properties of members of a population (e.g., customers) based on historical data or training data associated with that population (e.g., existing customers).

Approaches according to aspects of embodiments of the present disclosure improve the efficiency of machine learning systems, because previously trained models can be reused for other purposes. In contrast, training new models in an end-to-end manner (e.g., starting from raw training data) and retraining existing models incurs significant additional training costs (e.g., in computational time and energy to compute new parameters for the models), and where retraining an existing model may render the model unusable or hurt performance for the original purpose that the model was trained for or requires additional storage space to store both the original model and the retrained model.

In addition, embodiments of the present disclosure enable a modular approach to assembling pipelines of machine learning models that are self-supervised in their training processes. This allows users to easily specify desired inputs and outputs, in terms of data that is already available in historical data accessible to the data-driven inference system, such that the data-driven inference system automatically identifies the appropriate models to be connected in sequence (e.g., composed or connected into a chain or pipeline of one or more models). Furthermore, improvements in the accuracy of models propagates through to downstream models in a chain. For example, replacing an upstream model in a chain with a different model (e.g., retrained with additional data or replaced with a model having a different architecture) that has higher accuracy (e.g., precision and/or recall) means that the upstream model (or preceding model) produces more accurate inputs for the downstream models in the chain. The improved accuracy of the inputs to the downstream models improves the accuracy of those downstream models, even if the downstream models themselves have not changed (e.g., have not been retrained or replaced with different models).

Data-driven methods for making decisions improve upon processes that may otherwise be performed based on human intuition. One example is in the context of setting prices tailored for a specific customer. While many small customers may pay standard rates for goods and services, large customers (e.g., enterprises) may be charged discounted rates that are tailored to their business relationships with the providers of those goods and services. Different customers may purchase different selections of goods and services among the variety of services offered by a provider. Even customers who use or purchase the same goods or services may do so at different volumes, or with different proportions of those same goods and services. As such, one customer may receive a significant discount on a first product due to high usage and a smaller discount or no discount on a second product due to relatively low usage. On the other hand, the provider may choose to incentivize a customer to increase usage of a product by offering a promotional rate on a product to that customer.

One approach to setting prices is for sales professionals to review current pricing arrangements with existing customers to design a new proposed pricing arrangement for a current customer or a new customer. However, as noted above, different sales professionals may apply intuition to arrive at different proposed pricing arrangements for the same prospective customer or current customer.

In contrast, a data-driven approach to pricing applies automatically computes proposed pricing arrangements based on statistical analyses of existing pricing arrangements, such as by interpolating or extrapolating from historical or current pricing arrangements made with prior or current customers, e.g., using a regression model trained on training data.

As such, data-driven approaches improve rigor, predictability, and uniformity of decisions, because the decisions are made based on statistical analyses of historical data, instead of based on ad-hoc reasoning used by individuals (e.g., entirely mentally and/or using spreadsheets), where the results may differ between individuals making such decisions. Furthermore, the use of spreadsheets and intuition limits the number of parameters or features that can be considered when comparing customers, such as when tens or hundreds of features relating to different aspects of the customers are considered.

In cases where a provider interacts with a diverse population of customers, these customers may fall into different pricing domains or pricing categories. For example, different types of customers may be associated with different levels of risk and potential liability to the provider, which should be reflected in the prices that are quoted to those customers (e.g., customers in high-risk industries may be quoted higher prices than customers in low-risk industries). Accordingly, the regression model may need to account for these additional factors. On the other hand, a tradeoff of including additional factors (e.g., additional input features describing customers) can make computing these models more complex or may result in decreased accuracy or performance due to model training problems such as overfitting.

One approach to improving the accuracy of estimates computed by regression models is to cluster similar customers together and train separate regression models for each such cluster. This improves the accuracy of the computations (e.g., by reducing the risk of overfitting) and improves the training performance, because the size of the training dataset and is better correlated.

Aspects of embodiments of the present disclosure relate to reusing the same clustering model that was trained to clustering similar customers in multiple different contexts. As noted above, the clustering model can be used to identify cluster that is most similar to an input customer, and a corresponding cluster-specific regression model can then be used to compute pricing arrangements for that customer (e.g., based on identifying some number of similar customers within that cluster and performing regression based on characteristics of those customers and the pricing arrangement with those customers). Other types of cluster-specific regression models are trained to compute other characteristics of those customers, such as expected growth rates, churn rate, risk scores, and the like. The values computed by these cluster-specific regression models may be returned to a user or maybe be supplied as inputs to other models to perform further computations.

In addition, various models can be used alone, without being included in a pipeline or chain of models. For example, a clustering model can be used alone to perform outlier detection, such as detecting when a given input customer, as represented by a collection of features (e.g., represented as a feature vector), is an outlier that is different from other clusters or where a given pricing arrangement is an outlier that is very different from other pricing arrangements for similar customers (e.g., where difference may be represented by a large distance from others in an embedding space or latent space that the feature vectors are mapped into by a learned embedding function).

Accordingly, instead of creating separate machine learning pipelines or models for each separate question that users may be interested in (e.g., separate machine learning models for pricing guidance, outlier pricing detection, product recommendations, retention or churn rate predictions, and the like), embodiments of the present disclosure provide systems expose a simplified interface that automatically orchestrates user requests to a chain of multiple machine learning models or to a single machine learning model (e.g., a chain of one model) to perform a computation in accordance with the request. The decoupling of the models enables new models (e.g., new regression models) to be trained and added to the data-driven inference system 100 without disturbing the operation of the existing models and also enabling the new models to be combined with existing models in chains of models to request new types of user requests.

Embodiments of the present disclosure improve the performance of data-driven inference systems (or machine learning applications) because they automate the process of reducing the size of regression or classification models to members of clusters and subsequently performing inferences on input data samples based on identifying regression or classification models that are specific to corresponding ones of the clusters. This improves the quality of the inference results because the regression models are better fit to the members of the corresponding cluster and improves the efficiency of training the regression model because the number of data points is restricted to members of the cluster and because the modular machine learning models according to embodiments of the present disclosure are organized or chained together to implement specific inference computations without having to retrain the individual machine learning models.

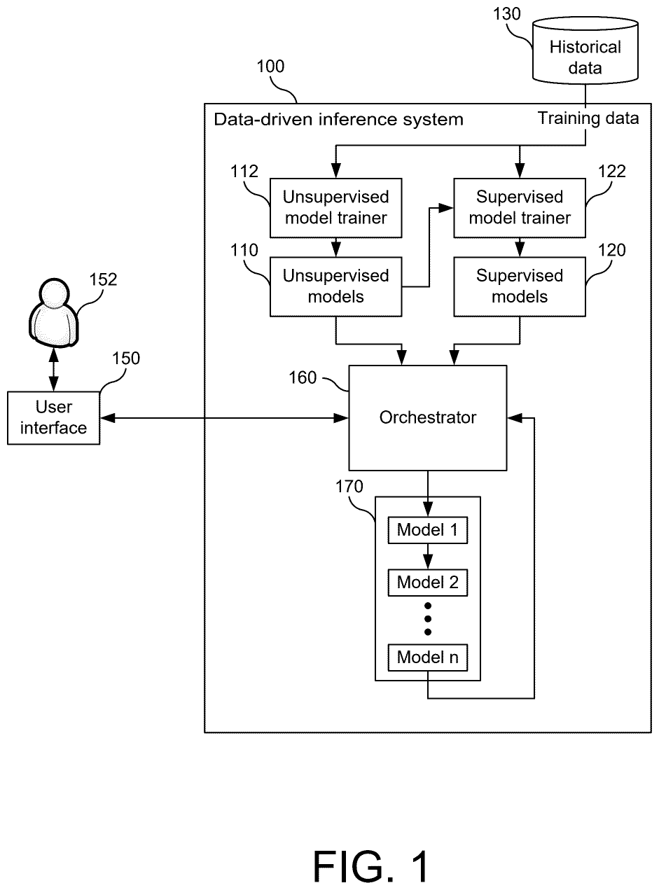

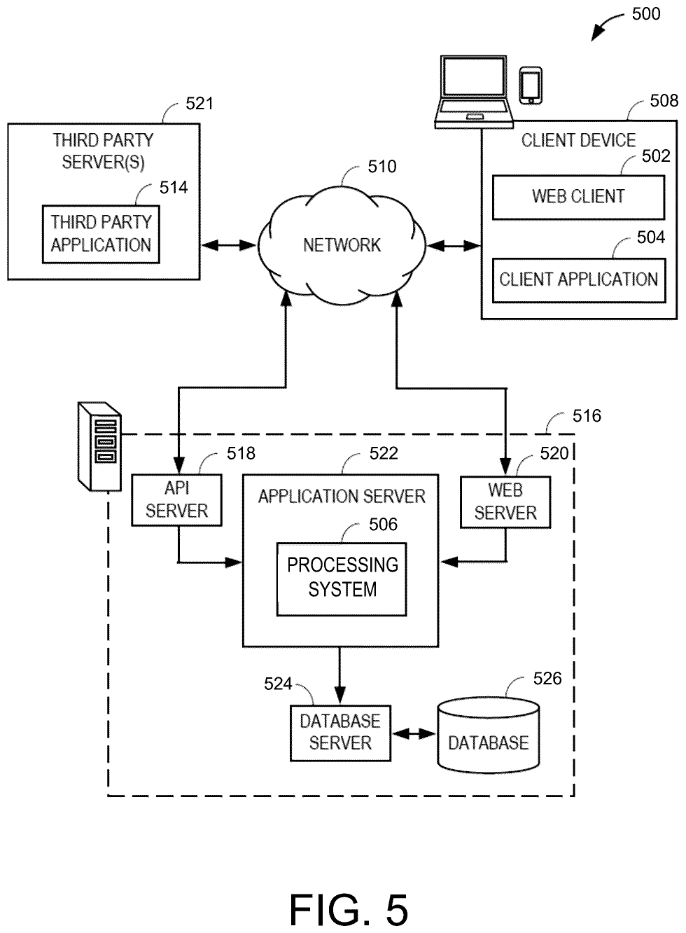

FIG. 1 is a block diagram illustrating a data-driven inference system 100 according to one embodiment of the present disclosure. The data-driven inference system 100 may also be referred to herein as a unified machine learning enabled framework. As shown in FIG. 1, the data-driven inference system 100 includes unsupervised models 110 and supervised models 120. The unsupervised models 110 may be trained by an unsupervised model trainer 112 and the supervised models 120 may be trained by a supervised model trainer 122, which use training data taken from a database of historical data 130. The unsupervised model trainer 112 and the supervised model trainer 122 may be implemented using one or more computer systems, such as the computing system environment shown and described in more detail below with respect to FIGS. 5-7.

The historical data may include data associated with predictions to be made using the unsupervised models 110 and the supervised models 120. For example, in the context of pricing guidance, the historical data 130 may include profiles describing attributes of current and prior customers of a provider and the pricing arrangements associated with those customers (e.g., per-product pricing arrangements, including changes in pricing based on sales volume, and the like). As noted above, other examples of historical data 130 include information about whether the customer is a current customer or, if not, how long each customer maintained their relationship with the provider (e.g., to compute retention rates or churn rates of customers), rates of fraudulent or otherwise risky activity from the customer (e.g., to compute liability or risk rates associated with customers), and the like.

A user interface 150 takes input from a user 152 and provides a request to an orchestrator 160 of the data-driven inference system 100. The orchestrator constructs, based on the request, a chain of one or more machine learning models 170 (labeled Model 1, Model 2, . . . , Model n in FIG. 1). The construction of this chain of one or more machine learning models 170 will be described in more detail below. As noted above, aspects of embodiments of the present disclosure relate to assembling combinations of one or more machine learning models from among the unsupervised models 110 and the supervised models 120 to respond to the request received from the user interface 150. In some embodiments, the orchestrator 160 of the data-driven inference system 100 receives requests from additional sources other than user interfaces 150, such as from automated systems for generating push messages (e.g., email messages, text messages, and the like), automated monitoring systems for analyzing data received or processed by other systems, and systems that take actions automatically based on events (e.g., automatically triggered based on date and time, automatically triggered by messages received from external environments, and the like).

An input received from the user interface 150 may be supplied to the chain of one or more machine learning models 170 to compute an inference or result, which is returned to the orchestrator 160 and routed to an appropriate destination, which may be specified by the request (e.g., routed back to the user interface 150 in the case of a request from a user 152).

In embodiments of the present disclosure, the orchestrator 160 may be analogized to a load balancer or router that directs traffic to one or more machine learning models (e.g., unsupervised models 110 and supervised models 120) that can be chained together, where the orchestrator 160 directs the flow of inputs and outputs of the machine learning models in the chain 170. As such, a single request received via the orchestrator can expand to n different calls to n different machine learning models in the chain 170.

As noted above, one example is obtaining a price for a specific customer. Obtaining a price could require calling a pricing guidance application programming interface (API), which may be exposed by the user interface 150 or the orchestrator 160.

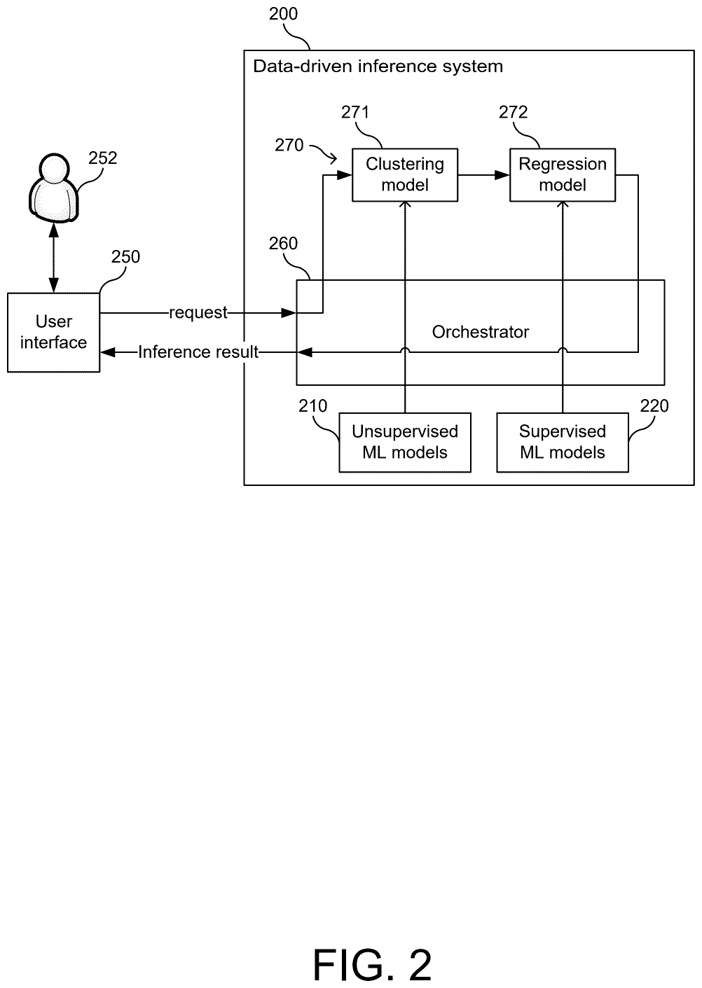

FIG. 2 is a block diagram illustrating the composition, by an orchestrator of a data-driven inference system 200, of two machine learning models into a chain to compute an inference value according to one embodiment of the present disclosure. The data-driven inference system 200 may be implemented using one or more computer systems, such as the computing system environment shown and described below with respect to FIGS. 5-7.

As shown in FIG. 2, the data-driven inference system 200 has access to a collection of unsupervised machine learning models 210 and supervised machine learning models 220. A user interface 250 allows a user 252 to enter information and may also display or otherwise present results to the user 252, such as through an attached display device and/or through audio or printing devices. An orchestrator 260 of the data-driven inference system 200 receives a request from the user interface 250, where the request may include a data sample that includes one or more features and an indication of a target property to be inferred.

For example, in the case of pricing guidance described above, the target property to be inferred is a price to be charged to the customer. The product offered by the service provider may relate to transaction processing services (e.g., for processing of payment cards such as credit cards and debit cards) The data sample includes known data about the customer in accordance with various properties or fields of a data model, such as payment volume, revenue per time period (e.g., average revenue per month), current set of products offered by the provider that are used by the customer (e.g., fraud detection and sales tax calculation products in addition to payment processing), industry segment (e.g., business-to-business versus business-to-consumer, digital goods, consumer products, consumables, services, and the like), geographic region, and other descriptions of characteristics of the customer.

The specific properties or fields of data model will differ depending on the type of data being processed by the data-driven inference system 200. In other contexts, such as providers offering different types of goods and/or services, the relevant characteristics of the customers may change. For example, a digital media platform offering streaming media services to its customers may use different data models with different sets of properties or fields to represent its customers (e.g., recent viewing history, personal ratings of viewed material, time spent viewing materials on a per-genre basis, current subscription plan, average amount spent on premium features, advertisement click-through-rates, and the like).

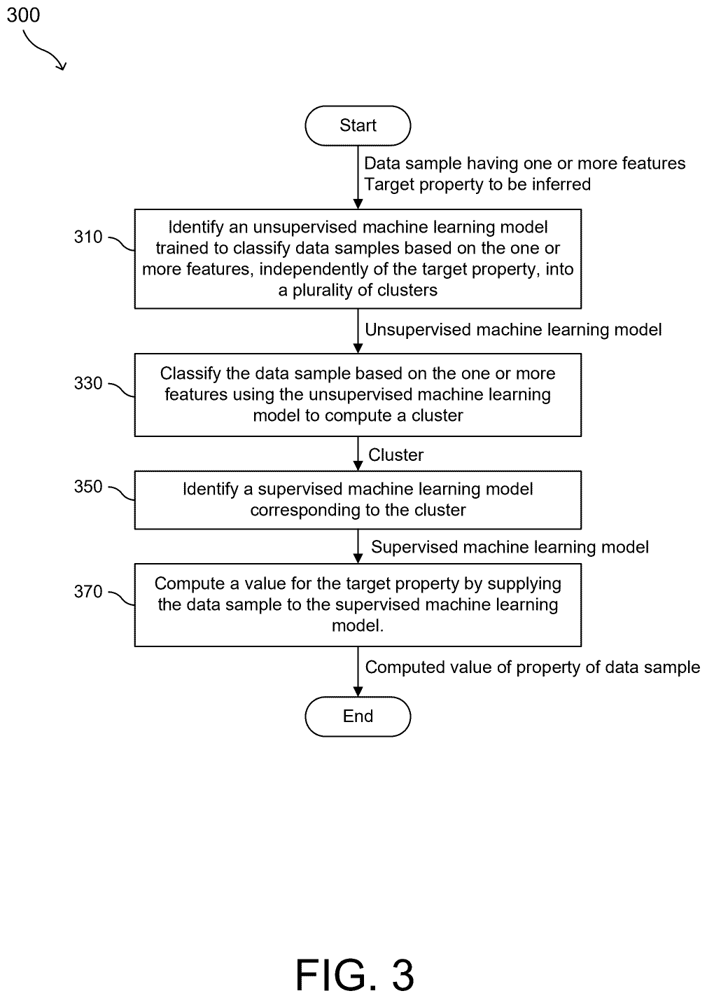

FIG. 3 is a flowchart of a method 300 for generating a chain of one or more machine learning models according to one embodiment of the present disclosure. The method 300 may be implemented, in some embodiments, by an orchestrator 260 operating within the data-driven inference system 200 implemented in a computing system environment.

As a concrete example, the method 300 may receive as input a data sample having one or more features and an identification of a target property to be inferred by the method 300. The machine learning models may be used to compute an inferred result value relating to the target property to be inferred. As one example, the target property to be inferred may be pricing guidance, such as a price sheet (e.g., per-product prices) to be offered to a customer based on properties or features of that customer, and in such an example, the inferred result value will be one or more per-product prices. In this example, a data sample having one or more features supplied as input to the method may include features that represent characteristics of the customer (e.g., geography, Industry segment, business-to-business versus business-to-consumer, total transaction volume, revenue, current products being used by the customer, and the like. The target property to be inferred in this example is the price that the customer should be charged for a particular product (or prices for a bundle of multiple products).

At 310, the processor implementing the orchestrator 260 selects an unsupervised machine learning model from among the unsupervised machine learning models 210 that are accessible to the orchestrator 260. Different unsupervised machine learning models 210 may be trained based on different subsets of the properties or fields of the data model. The method 300 shown in FIG. 3 uses machine learning models trained based on historical data 130 to calculate a value for the target property to be inferred (the pricing of a product or products) based on pricing offered to similar customers, where the features of the customer are used to identify those similar customers.

As shown in FIG. 1, the unsupervised model trainer 112 trains the unsupervised models 110 based on training data received from historical data 130. The training data may conform to a data model specifying a plurality of different fields (examples of which were given above). A given request from a user 152 may request an inference (or prediction or estimate) regarding the value of a specific target property or field of the data model, based on values of one or more of the fields of the data model. The data samples of the training data may cluster in different ways or in different patterns depending on which fields of the data model are included when training the unsupervised learning model. Continuing the above example, certain features of the customer may be known, such as by being self-reported by the customer (e.g., geography and industry segment, etc.). Other features of the customer may not be available (e.g., total revenue in the case of new customers of the platform) or may be unreliable due to being self-reported by the customer. The target property to be inferred may also be unavailable, as this is the desired output of the method 300. The known or available features of the data sample can be used as inputs for the unsupervised machine learning model, and as such the unsupervised machine learning model may be trained to cluster customers based on these known features.

One example of an unsupervised learning model is k-means clustering, which aims to partition the data into k different clusters, where each observation belongs to the cluster with the nearest mean (cluster centers or cluster centroids). Each observation may be represented as a vector (or feature vector) of numbers computed from selected fields of the data model, and the distances between the observations (or data samples) and the cluster centers are calculated based on the numerical values in the feature vectors. The value of the hyperparameter k (e.g., the number of clusters) may be computed based on, for example, the elbow method and silhouette analysis.

In some embodiments, the unsupervised model trainer 122 determines a distribution of values (e.g., probabilistic distribution) for each cluster or segment based on the historical data (e.g., billing invoices and associated pricing data) of the observations that belong to the cluster. In some embodiments, the distribution is calculated based on one or more pricing parameters. An example pricing parameter for which a distribution may be generated may be a type of rate (e.g. a variable rate), and the probabilistic distribution may include values of the variable rate associated with the customers in the customer segment.

In some embodiments, an outlier threshold is calculated for a probabilistic distribution generated for a cluster or customer segment. The outlier threshold may be used for determining outlier values for the distribution. In some embodiments, the outlier threshold is calculated according to the following formula, although embodiments are not limited thereto:

$$Lower Outlier Threshold = {25}^{th} percentile - 1.5 * IQR ( N )$$

$$Upper Outlier Threshold = {75}^{th} percentile + 1.5 * IQR ( N )$$

where IQR is the interquartile range IQR of distribution N.

Accordingly, a trained unsupervised outlier detection model may determine that a value of a pricing parameter is anomalous if the value is outside of the outlier threshold of the corresponding distribution.

Accordingly, in some embodiments, at 310 the orchestrator 260 selects an appropriate unsupervised learning model from the collection of unsupervised machine learning models 210 based on matching the given one or more features (or fields of independent variables) in the request with an unsupervised learning model that was trained based on that set of fields. In some embodiments, the request may specify which fields of the data sample to use when selecting an unsupervised model (e.g., a subset of the fields may be used to select an unsupervised model, and the unsupervised model may use only the subset of the fields). The unsupervised machine learning models 210 may include various trained unsupervised learning models, where these trained unsupervised learning models may have the form of clustering models such as hierarchical clustering, density-based spatial clustering of applications with noise (DBSCAN), gaussian mixture models, spectral clustering, and the like.

At 330, the orchestrator supplies the one or more features of the data sample as received from the request to the unsupervised model to compute a cluster associated with the data sample of the request. The resulting cluster includes various samples from the historical data 130, such as existing or prior customers of the platform, that are similar to the input data sample. The similarity, as discussed above, is computed based on the one or more features of the data sample-features of the customer, such as geographic area, industry vertical, revenue range, currently-subscribed products from the platform, and the like.

As noted above, in some embodiments of the present disclosure, the data-driven inference system 200 provides access to a plurality of supervised machine learning models 220 that are trained on a per-cluster basis. In more detail, as shown in FIG. 1, the supervised model trainer 122 may use an unsupervised model from the unsupervised models 110 to partition the training data (received from historical data 130) into clusters (e.g. k different clusters or k₁ different clusters) and train a separate supervised model for each such cluster resulting in a plurality of supervised models 120. The supervised model may be, for example, a continuous or regression based model, including linear and non-linear regression models such as: a linear regression model, a regression forest (e.g., random forest regression), gradient boosted regression, logistic regression, and/or the like. The supervised model may also be, for example, a discrete or classifier model such as gradient boosted trees (e.g., XGBoost), a neural network, a support vector machine, a Bayesian classifier, and/or the like, but embodiments of the present disclosure are not limited thereto. As a specific example, a given supervised model may be trained to predict per-product pricings for a given customer, as described based on a subset of the one or more fields of the data model. These per-product pricings may be computed based on finding prices (or ranges of prices) that aligned or consistent with (e.g., interpolated between) prices that are quoted or charged or paid by other customers in the cluster (e.g., the most similar customers in the cluster).

At 350, the orchestrator 260 identifies a supervised machine learning model corresponding to the cluster that was computed at 330. This generates a chain 270 of models, beginning with the unsupervised model (or clustering model 271) identified at 310 and the supervised machine learning model (or regression model 272) identified by the orchestrator 260 at 350.

At 370, the orchestrator 260 supplies one or more features of the data sample (which may be different from the subset of features used to select the unsupervised machine learning model or used to compute the cluster associated with the data sample at 350) to the supervised machine learning model to compute the value of the target property (or field). This results in an inferred result value, termed as such because a statistical inference is computed by the model as trained by the training data. Continuing the above example, the inferred result value may include, for example, a price to be charged to a customer for a product (e.g., 1.2% per transaction) as computed by the supervised model based on the most similar customers within the cluster identified by the unsupervised learning model. In some embodiments, the inferred result value (e.g., the computed price or prices) is returned (e.g., provided) to the user 252. In some embodiments, the inferred result value is used to influence an aspect of the environment, such as by generating reports, triggering automated actions in other computer systems (e.g., by sending messages to other computer systems outside of the data-driven inference system 100), or sending messages to entities.

While this example of FIG. 2 and FIG. 3 shows a case where the chain of machine learning models 270 has two machine learning models, embodiments of the present disclosure are not limited thereto.

For example, in some embodiments, the orchestrator 260 supplies the output of the supervised machine learning model as input to another model to compute the inferred result value. Continuing the example above of pricing guidance, the supervised model may filter the cluster to identify the most similar observations within the cluster (e.g., identifying data samples in the historical data 130 that are closest to the centroid of the cluster in the embedding space of the feature vectors), and supply those identified most similar observations (k nearest neighbor observations, where this value of k does not need to be same as the number of clusters and may be referred to herein as k₂ nearest neighbors). These k nearest neighbor observations may then be chained as input into a k-nearest neighbors algorithm to perform regression (e.g., linear regression) based on those k nearest neighbor observations to compute an inferred pricing for the input data sample in accordance with those k nearest neighbor observations (the k customers that are most similar to the input customer from within the same cluster).

As a further example, in some embodiments, the resulting inferred result value may be chained (supplied as input) back into the unsupervised machine learning model to perform outlier detection on the inferred result value. This may operate as a check as to whether the inferred result value is reasonable (e.g., not an outlier). Determining that the inferred result value (e.g., a predicted price for this customer) is an outlier may result in re-running the pricing guidance prediction with different parameters (e.g., a different subset of the features of the data model to potentially select a different group of k nearest neighbors), and/or returning a response that includes a warning indicating that the inferred result value may be an outlier (e.g., statistically different from other inferred values associated with the cluster).

In some cases, a single model is sufficient to respond to the request. For example, if the request relates to anomaly detection or outlier detection, then the clustering model 271 may be sufficient to determine whether the current data sample is an outlier that is distant from all other data samples or observations in the training data based on the historical data. The output of this chain of one machine learning model is then returned as the response or result of the computation (e.g., a likelihood or probability or confidence that the input data sample is an outlier).

Accordingly, the orchestrator 260 constructs a chain of one or more machine learning models 270 to respond to an incoming request by selecting from unsupervised machine learning models 210 and/or supervised machine learning models 220. The orchestrator 260 may select a first model (e.g., an unsupervised machine learning model) based on matching inputs to the model that correspond to (e.g., are a subset of) the features (e.g., known fields) of a data sample in the request. The orchestrator 260 may also select an output model that has an output corresponding to the requested output of the request (e.g., the target property or field to be inferred based on the input data sample), where this model may be the same as the first model or may be different from the first model. Other machine learning models may be included in a chain between the first model and the output model or after the output model, where these additional models may, for example, provide filtering (e.g., select a cluster, filter for k nearest neighbors, and the like), compute intermediate inferred values for values that are absent (e.g., unknown numbers in the input data) that are supplied as inputs to other models that expect such values (e.g., a new customer may have no value for payment volume over the past three months and therefore this value may be absent from a data sample representing the customer, where another model may require such a value as input: inferring what the payment volume might have been based on other known data about the new customer may allow the other model to be used), enrich the output (e.g., providing outlier detection on the inferred result value), and the like.

While the embodiments illustrated in FIG. 1 and FIG. 2 show a separate orchestrator 160 as part of the data-driven inference system 100, embodiments of the present disclosure are not limited thereto and can be implemented as a modification of existing infrastructure.

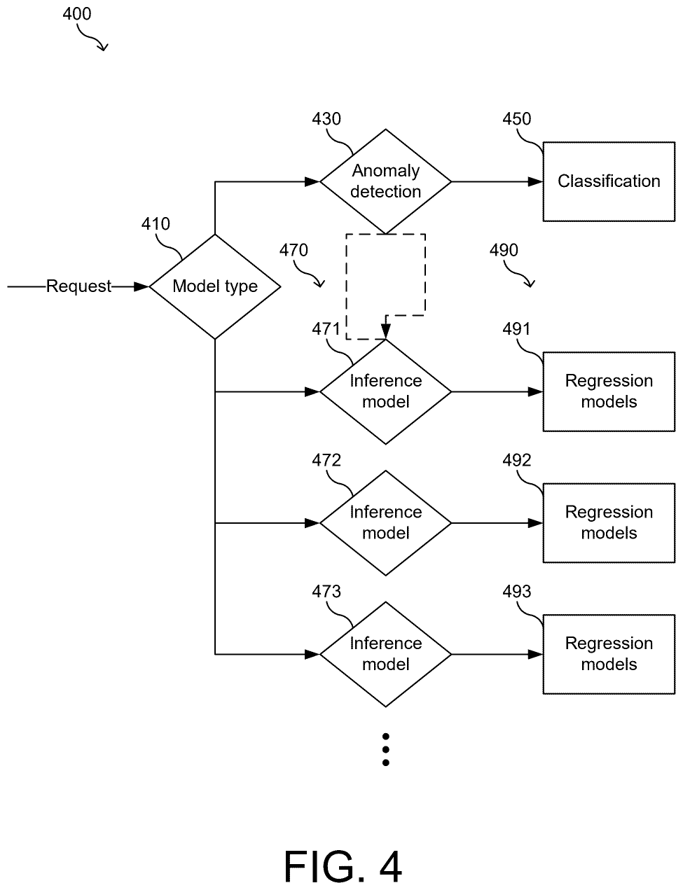

FIG. 4 is a block diagram of a data-driven inference system 400 in which an existing interface (e.g., application programming interface) for interacting with an outlier detection machine learning model is modified to accept requests and to orchestrate chains of machine learning models according to one embodiment of the present disclosure.

In some circumstances, an anomaly detection machine learning model may already expose an interface (e.g., an application programming interface) that specifies a data format for incoming requests to perform anomaly detection, such as a classification of a data sample or observation supplied with a request (e.g., as represented by a set of values or feature vectors corresponding a collection of fields in accordance with a data model). The data format of the request may allow the inclusion of metadata, such as a payload of additional data. In some embodiments, the metadata includes a field that specifies the type of response requested (e.g., the target property of the data model).

As shown in FIG. 4, the data-driven inference system 400 according to some embodiments of the present disclosure includes a decision block 410 that determines the model type based on the field in the request that specifies the type of response. Based on the value of that field, the request is routed to an anomaly detection model 430 to compute a classification 450 (e.g., a classification of the data sample in the request as an anomaly or non-anomaly or alternatively as a likelihood or probability that the data sample is an anomaly) or to inference models 470 to compute an inference that may be supplied to regression models 490. The inference models 470 may include, as discussed above, a pricing guidance model for selecting k nearest neighbors and the regression models may perform linear regression based on those k nearest neighbors. As noted above, in some circumstances, the inference models 470 may also invoke the anomaly detection model 430 to check whether the inferred result value is anomalous.

In some embodiments, the decision block 410 may be configured to route requests to the anomaly detection model 430 by default in cases where the field specifying the type of response is omitted, thereby retaining compatibility with requesters that have not updated their request formats to use this additional functionality.

As a specific example, a model type field in the request may have an integer data type, where different values are associated with different inference models. The decision block 410 selects an inference model from among the inference models 470 based on the value in the model type field of the received request. A value of 1 in the model type field may be associated with a pricing guidance model 471 as discussed above for computing a price based on linear regression on k nearest neighbors in a cluster identified by the anomaly detection model 430 using first regression models 491. A value of 2 in the model type field may be associated with a risk score model 472, where a given customer is analyzed for risks (e.g., liability) associated with that customer, based on a regression analysis on the risk scores associated with k nearest neighbors in a cluster identified by the anomaly detection model using second regression models 492. A value of 3 in the model type field may be associated with a churn rate model 473, which estimates how long the customer is expected to continue using the products of the provider using third regression models 493. Client computer systems or software that access the data-driven inference system 400 without specifying a model type (e.g., omitting the model type from the request) may be routed default to only the anomaly detection model 430, such that the data-driven inference system 400 retains backward compatibility with such client computer systems.

As such, aspects of embodiments of the present disclosure relate to automated self-supervised machine learning services that provide access to data-driven inference systems. Some aspects of embodiments of the present disclosure relate to the automatic configuration and training of unsupervised machine learning models and supervised machine learning models to compute inferences or inferred result values representing predictions of properties of new data samples based on automatically statistically analyzing historical data samples (e.g., prior data and current data). One example use case described above relates to automatically identifying clusters of customers that are similar based on various characteristics of those customers (e.g., geography, industry segment, revenue, and the like), identifying a cluster that a new customer or an existing customer is a member of based on similarity to that cluster, and using members of the identified cluster to infer a pricing scheme for that new customer or existing customer (e.g., by interpolating between or extrapolating from the pricing schemes associated with those similar customers within the cluster). Automating the computation of statistical inferences in this manner improves the computations performed by non-data scientists, by providing data-driven approaches rather than ad-hoc mental estimates. Furthermore, the automation of the processes removes the burden of developing models from data scientists and other specialists in the field of data analysis, and the re-use of models across different inferences reduces the computational load on the computer systems that execute the computations.

With reference to FIG. 5, an example embodiment of a high-level SaaS network architecture 500 is shown. A networked system 516 provides server-side functionality via a network 510 (e.g., the Internet or a WAN) to a client device 508. A web client 502 and a programmatic client, in the example form of a client application 504 (e.g., client software for accessing the data-driven inference system, such as implementing a user interface 150), are hosted and execute on the client device 508. The networked system 516 includes one or more servers 522 (e.g., servers hosting services exposing remote procedure call APIs), which hosts a processing system 506 (such as the processing system described above according to various embodiments of the present disclosure supporting service for automatically processing accounting data) that provides a number of functions and services via a service oriented architecture (SOA) and that exposes services to the client application 504 that accesses the networked system 516 where the services may correspond to particular workflows. The client application 504 also provides a number of interfaces described herein, which can present an output in accordance with the methods described herein to a user of the client device 508.

The client device 508 enables a user to access and interact with the networked system 516 and, ultimately, the processing system 506. For instance, the user provides input (e.g., touch screen input or alphanumeric input) to the client device 508, and the input is communicated to the networked system 516 via the network 510. In this instance, the networked system 516, in response to receiving the input from the user, communicates information back to the client device 508 via the network 510 to be presented to the user.

An API server 518 and a web server 520 are coupled, and provide programmatic and web interfaces respectively, to the servers 522. For example, the API server 518 and the web server 520 may produce messages (e.g., RPC calls) in response to inputs received via the network, where the messages are supplied as input messages to workflows orchestrated by the processing system 506. The API server 518 and the web server 520 may also receive return values (return messages) from the processing system 506 and return results to calling parties (e.g., web clients 502 and client applications 504 running on client devices 508 and third-party applications 514) via the network 510. The servers 522 host the processing system 506, which includes components or applications in accordance with embodiments of the present disclosure as described above. The servers 522 are, in turn, shown to be coupled to one or more database servers 524 that facilitate access to information storage repositories (e.g., databases 526). In an example embodiment, the databases 526 includes storage devices that store information accessed and generated by the processing system 506, such as the historical data 130 of FIG. 1, and other databases such as databases storing information associated with transactions processed by a business.

Additionally, a third-party application 514, executing on one or more third-party servers 521, is shown as having programmatic access to the networked system 516 via the programmatic interface provided by the API server 518. For example, the third-party application 514, using information retrieved from the networked system 516, may support one or more features or functions on a website hosted by a third-party. For example, the third-party application 514 may serve as a data source for retrieving, for example, training data from historical data 130.

Turning now specifically to the applications hosted by the client device 508, the web client 502 may access the various systems (e.g., the processing system 506) via the web interface supported by the web server 520. Similarly, the client application 504 (e.g., an “app” such as a payment processor app or an application or user interface for interacting with the data-driven inference system 100) may access the various services and functions provided by the processing system 506 via the programmatic interface provided by the API server 518. The client application 504 may be, for example, an “app” executing on the client device 508, such as an iOS or Android OS application to enable a user to access and input data on the networked system 516 in an offline manner and to perform batch-mode communications between the client application 504 and the networked system 516.

Further, while the network architecture 500 shown in FIG. 5 employs a client-server architecture, the present disclosure is not limited to such an architecture, and could equally well find application in a distributed, or peer-to-peer, architecture system, for example.

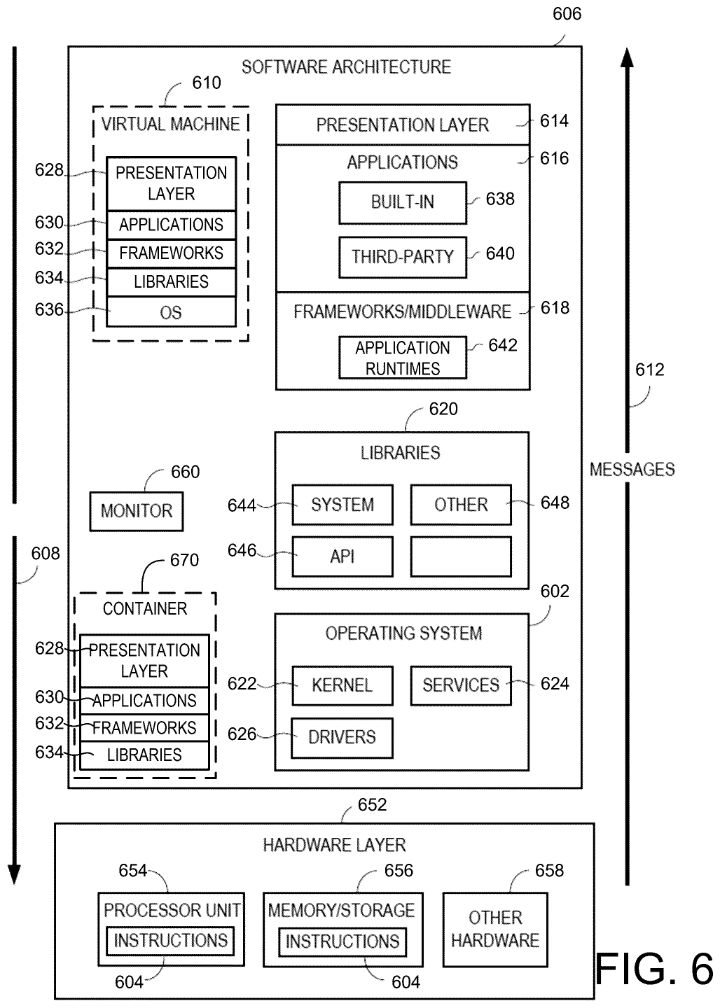

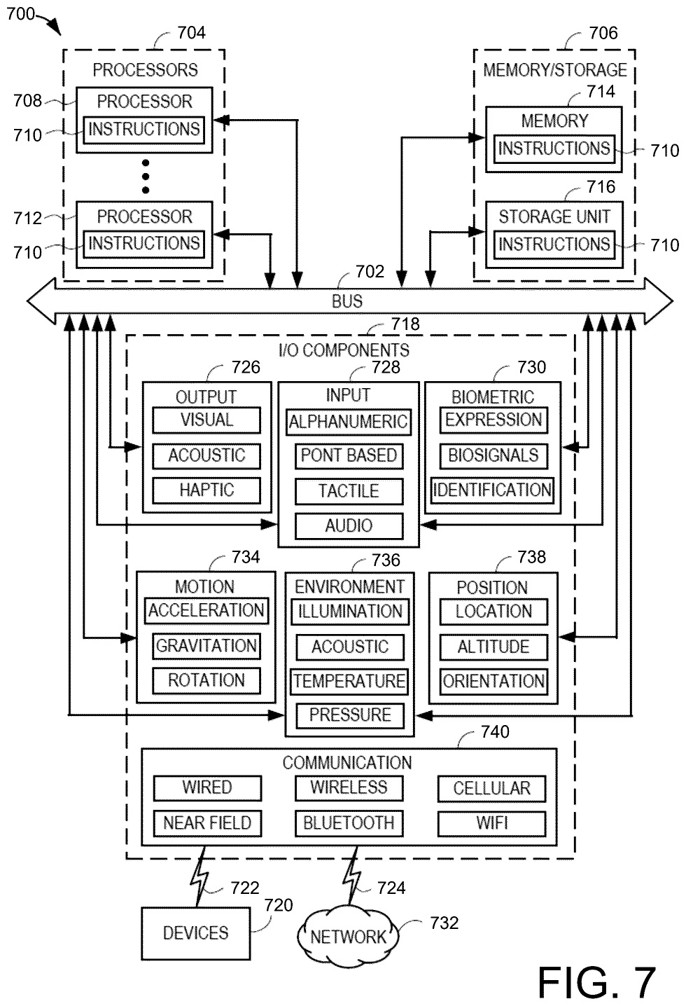

FIG. 6 is a block diagram illustrating an example software architecture 606, which may be used in conjunction with various hardware architectures herein described. FIG. 6 is a non-limiting example of a software architecture 606, and it will be appreciated that many other architectures may be implemented to facilitate the functionality described herein. The software architecture 606 may execute on hardware such as a machine 700 of FIG. 7 that includes, among other things, processors 704, memory/storage 706, and input/output (I/O) components 718. A representative hardware layer 652 is illustrated and can represent, for example, the machine 700 of FIG. 7. The representative hardware layer 652 includes a processor 654 having associated executable instructions 604. The executable instructions 604 represent the executable instructions of the software architecture 606, including implementation of the methods, components, and so forth described herein. The hardware layer 652 also includes non-transitory memory and/or storage modules as memory/storage 656, which also have the executable instructions 604. The hardware layer 652 may also include other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616 (such as the services of the processing system), and a presentation layer 614. Operationally, the applications 616 and/or other components within the layers may invoke API calls 608 through the software stack and receive a response as messages 612 in response to the API calls 608. The layers illustrated are representative in nature, and not all software architectures have all layers. For example, some mobile or special-purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than by interfacing directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 620 may also include a wide variety of other libraries 648 to provide many other APIs to the applications 616 and other software components/modules.

The frameworks/middleware 618 provide a higher-level common infrastructure that may be used by the applications 616 and/or other software components/modules. For example, the frameworks/middleware 618 may provide high-level resource management functions, web application frameworks, application runtimes 642 (e.g., a Java virtual machine or JVM), and so forth. The frameworks/middleware 618 may provide a broad spectrum of other APIs that may be utilized by the applications 616 and/or other software components/modules, some of which may be specific to a particular operating system or platform.

The applications 616 include built-in applications 638 and/or third-party applications 640. The applications 616 may use built-in operating system functions (e.g., kernel 622, services 624, and/or drivers 626), libraries 620, and frameworks/middleware 618 to create user interfaces to interact with users of the system. Alternatively, or additionally, in some systems, interactions with a user may occur through a presentation layer, such as the presentation layer 614. In these systems, the application/component “logic” can be separated from the aspects of the application/component that interact with a user.

Some software architectures use virtual machines. In the example of FIG. 6, this is illustrated by a virtual machine 610. The virtual machine 610 creates a software environment where applications/components can execute as if they were executing on a hardware machine (such as the machine 700 of FIG. 7, for example). The virtual machine 610 is hosted by a host operating system (e.g., the operating system 602 in FIG. 6) and typically, although not always, has a virtual machine monitor 660 (or hypervisor), which manages the operation of the virtual machine 610 as well as the interface with the host operating system (e.g., the operating system 602). A software architecture executes within the virtual machine 610 such as an operating system (OS) 636, libraries 634, frameworks 632, applications 630, and/or a presentation layer 628. These layers of software architecture executing within the virtual machine 610 can be the same as corresponding layers previously described or may be different.

Some software architectures use containers 670 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 670 is similar to a virtual machine in that it includes a software architecture including libraries 634, frameworks 632, applications 630, and/or a presentation layer 628, but omits an operating system and, instead, communicates with the underlying host operating system 602.

FIG. 7 is a block diagram illustrating components of a machine 700, according to some example embodiments, able to read instructions from a non-transitory machine-readable medium (e.g., a computer-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or in parallel or concurrently, that specify actions to be taken by the machine 700. Further, while only a single machine 700 is illustrated, the term “machine” or “processing circuit” shall also be taken to include a collection of machines that individually or jointly execute the instructions 710 to perform any one or more of the methodologies discussed herein.

The machine 700 may include processors 704 (including processors 708 and 712), memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of the processors 704 are examples of machine-readable media.

The I/O components 718 may include a wide variety of components to receive input, provide output, produce output, transmit information, exchange information, capture measurements, and so on. The specific I/O components 718 that are included in a particular machine will depend on the type of machine. For example, portable machines such as mobile phones may include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion, and the grouping is in no way limiting. In various example embodiments, the I/O components 718 may include output components 726 and input components 728. The output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environment components 736, or position components 738, among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 may include acceleration sensor components (e.g., accelerometer), gravitation sensor components, rotation sensor components (e.g., gyroscope), and so forth. The environment components 736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via a coupling 724 and a coupling 722, respectively. For example, the communication components 740 may include a network interface component or other suitable device to interface with the network 732. In further examples, the communication components 740 may include wired communication components, wireless communication components, cellular communication components, Near Field Communication (NFC) components, Bluetooth® components (e.g., Bluetooth®) Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

According to one embodiment of the present disclosure, a method for generating a chain of machine learning models includes: receiving a data sample including one or more features and a target property; identifying, by a processor of a computer system, an unsupervised machine learning model trained to classify data samples based on the one or more features, independently of the target property, into a plurality of clusters; classifying the data sample based on the one or more features using the unsupervised machine learning model to compute a cluster; identifying, by the processor, a supervised machine learning model corresponding to the cluster; and computing a value for the target property by supplying the data sample to the supervised machine learning model.

The one or more features may be selected from a plurality of fields of a data model, and the unsupervised machine learning model may be identified from among a plurality of unsupervised machine learning models trained to classify data samples based on different combinations of fields of the data model.

The supervised machine learning model may include one or more selected from the group including: a linear regression model; a non-linear regression model; or a classification model.

The unsupervised machine learning model may include a clustering model.

The unsupervised machine learning model may include an anomaly detection model.

The method may further include supplying the value for the target property computed based on the supervised machine learning model to the anomaly detection model to compute a likelihood that the value for the target property is anomalous.

The method may further include: receiving a second data sample including one or more features and a second target property, the second target property being different from the target property of the data sample; classifying the second data sample based on the one or more features of the second data sample using the unsupervised machine learning model to compute a second cluster; identifying, by the processor, a second supervised machine learning model corresponding to the cluster; and computing a second value for the second target property by supplying the second data sample to the second supervised machine learning model.

The supervised machine learning model may compute the cluster based on a first subset of the one or more features of the data sample, and the supervised machine learning model may compute the value for the target property based on a second subset of the one or more features of the data sample, the second subset being different from the first subset.

According to one embodiment of the present disclosure, a system includes: a processor; and a memory storing instructions that, when executed by the processor, cause the processor to: receive a data sample including one or more features and a target property; identify a first machine learning model trained to classify data samples based on the one or more features, independently of the target property, into a plurality of clusters; classify the data sample based on the one or more features using the first machine learning model to compute a cluster; identify a second machine learning model corresponding to the cluster; and compute a value for the target property by supplying the data sample to the second machine learning model.

The one or more features may be selected from a plurality of fields of a data model, and the first machine learning model may be identified from among a first plurality of machine learning models trained to classify data samples based on different combinations of fields of the data model.

The second machine learning model may include one or more selected from the group including: a linear regression model; a non-linear regression model; or a classification model.

The first machine learning model may include a clustering model.

The first machine learning model may include an anomaly detection model.

The memory may further store instructions that, when executed by the processor, cause the processor to supply the value for the target property computed based on the second machine learning model to the anomaly detection model to compute a likelihood that the value for the target property is anomalous.

The memory may further store instructions that, when executed by the processor, cause the processor to: receive a second data sample including one or more features and a second target property, the second target property being different from the target property of the data sample; classify the second data sample based on the one or more features of the second data sample using the first machine learning model to compute a second cluster; identify a third machine learning model corresponding to the cluster; and compute a second value for the second target property by supplying the second data sample to the third machine learning model.

The second machine learning model may compute the cluster based on a first subset of the one or more features of the data sample, and the second machine learning model may compute the value for the target property based on a second subset of the one or more features of the data sample, the second subset being different from the first subset.

According to one embodiment of the present disclosure, a non-transitory computer-readable medium stores instructions that, when executed by a processor, cause the processor to: receive a data sample including one or more features and a target property; identify a first machine learning model trained to classify data samples based on the one or more features, independently of the target property, into a plurality of clusters; classify the data sample based on the one or more features using the first machine learning model to compute a cluster; identify a second machine learning model corresponding to the cluster; compute an intermediate value by supplying the data sample to the second machine learning model; identify a third machine learning model corresponding to the cluster; and compute a value for the target property by supplying the data sample and the intermediate value to the third machine learning model.

A value corresponding to the intermediate value may be absent from the data sample.

The non-transitory computer-readable medium may further include instructions that, when executed by the processor, cause the processor to: receive a second data sample including one or more features different from the one or more features of the data sample and a second target property, the second target property being different from the target property of the data sample; classify the second data sample based on the one or more features of the second data sample using a fourth machine learning model different from the first machine learning model to compute a second cluster; identify a fifth machine learning model corresponding to the cluster; and compute a value for the second target property by supplying the second data sample to the fifth machine learning model.

The non-transitory computer-readable medium may further include instructions that, when executed by the processor, cause the processor to: receive a third data sample including one or more features; identify the first machine learning model trained to classify data samples based on the one or more features into the plurality of clusters; and detect an anomaly in the data sample based on the one or more features using the first machine learning model.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for generating a chain of machine learning models comprising:
receiving a data sample comprising one or more features and a target property;
identifying, by a processor of a computer system, an unsupervised machine learning model trained to classify data samples based on the one or more features, independently of the target property, into a plurality of clusters;
classifying the data sample based on the one or more features using the unsupervised machine learning model to compute a cluster;
identifying, by the processor, a supervised machine learning model corresponding to the cluster; and
computing a value for the target property by supplying the data sample to the supervised machine learning model.

2. The method of claim 1, wherein the one or more features are selected from a plurality of fields of a data model, and
wherein the unsupervised machine learning model is identified from among a plurality of unsupervised machine learning models trained to classify data samples based on different combinations of fields of the data model.

3. The method of claim 1, wherein the supervised machine learning model comprises one or more selected from the group comprising:
a linear regression model;
a non-linear regression model; or
a classification model.

4. The method of claim 1, wherein the unsupervised machine learning model comprises a clustering model.

5. The method of claim 1, wherein the unsupervised machine learning model comprises an anomaly detection model.

6. The method of claim 5, further comprising supplying the value for the target property computed based on the supervised machine learning model to the anomaly detection model to compute a likelihood that the value for the target property is anomalous.

7. The method of claim 1, further comprising:
receiving a second data sample comprising one or more features and a second target property, the second target property being different from the target property of the data sample;
classifying the second data sample based on the one or more features of the second data sample using the unsupervised machine learning model to compute a second cluster;
identifying, by the processor, a second supervised machine learning model corresponding to the cluster; and
computing a second value for the second target property by supplying the second data sample to the second supervised machine learning model.

8. The method of claim 1, wherein the supervised machine learning model computes the cluster based on a first subset of the one or more features of the data sample, and
wherein the supervised machine learning model computes the value for the target property based on a second subset of the one or more features of the data sample, the second subset being different from the first subset.

9. A system comprising:
a processor; and
a memory storing instructions that, when executed by the processor, cause the processor to:
receive a data sample comprising one or more features and a target property;
identify a first machine learning model trained to classify data samples based on the one or more features, independently of the target property, into a plurality of clusters;
classify the data sample based on the one or more features using the first machine learning model to compute a cluster;
identify a second machine learning model corresponding to the cluster; and
compute a value for the target property by supplying the data sample to the second machine learning model.

10. The system of claim 9, wherein the one or more features are selected from a plurality of fields of a data model, and
wherein the first machine learning model is identified from among a first plurality of machine learning models trained to classify data samples based on different combinations of fields of the data model.

11. The system of claim 9, wherein the second machine learning model comprises one or more selected from the group comprising:
a linear regression model;
a non-linear regression model; or
a classification model.

12. The system of claim 9, wherein the first machine learning model comprises a clustering model.

13. The system of claim 9, wherein the first machine learning model comprises an anomaly detection model.

14. The system of claim 13, wherein the memory further stores instructions that, when executed by the processor, cause the processor to supply the value for the target property computed based on the second machine learning model to the anomaly detection model to compute a likelihood that the value for the target property is anomalous.

15. The system of claim 9, wherein the memory further stores instructions that, when executed by the processor, cause the processor to:
receive a second data sample comprising one or more features and a second target property, the second target property being different from the target property of the data sample;
classify the second data sample based on the one or more features of the second data sample using the first machine learning model to compute a second cluster;
identify a third machine learning model corresponding to the cluster; and
compute a second value for the second target property by supplying the second data sample to the third machine learning model.

16. The system of claim 9, wherein the second machine learning model computes the cluster based on a first subset of the one or more features of the data sample, and
wherein the second machine learning model computes the value for the target property based on a second subset of the one or more features of the data sample, the second subset being different from the first subset.

17. A non-transitory computer-readable medium storing instructions that, when executed by a processor, cause the processor to:
receive a data sample comprising one or more features and a target property;
identify a first machine learning model trained to classify data samples based on the one or more features, independently of the target property, into a plurality of clusters;
classify the data sample based on the one or more features using the first machine learning model to compute a cluster;
identify a second machine learning model corresponding to the cluster;
compute an intermediate value by supplying the data sample to the second machine learning model;
identify a third machine learning model corresponding to the cluster; and
compute a value for the target property by supplying the data sample and the intermediate value to the third machine learning model.

18. The non-transitory computer-readable medium of claim 17, wherein a value corresponding to the intermediate value is absent from the data sample.

19. The non-transitory computer-readable medium of claim 17, further comprising instructions that, when executed by the processor, cause the processor to:
receive a second data sample comprising one or more features different from the one or more features of the data sample and a second target property, the second target property being different from the target property of the data sample;
classify the second data sample based on the one or more features of the second data sample using a fourth machine learning model different from the first machine learning model to compute a second cluster;
identify a fifth machine learning model corresponding to the cluster; and
compute a value for the second target property by supplying the second data sample to the fifth machine learning model.

20. The non-transitory computer-readable medium of claim 17, further comprising instructions that, when executed by the processor, cause the processor to:
receive a third data sample comprising one or more features;
identify the first machine learning model trained to classify data samples based on the one or more features into the plurality of clusters; and
detect an anomaly in the data sample based on the one or more features using the first machine learning model.
